(19) United States
(12) Patent Application Publication
(10) Pub. No.: US 2026/0209057 A1
(43) Pub. Date: Jul. 23, 2026

(54) Lithium Recovery System via Fog Atomization in CO2-Rich Environment

(71) Applicant: Luke Seed, Cardiff, CA (US)

(72) Inventor: Luke Seed, Cardiff, CA (US)

(73) Assignee: Artifex RDE LLC, Cardiff, CA (US)

(21) Appl. No.: 19/578,100

(22) Filed: Mar. 25, 2026

Related U.S. Application Data
(60) Provisional application No. 63/791,081, filed on Apr. 18, 2025.

(51) Int. Cl. C01D 15/08; B01J 19/24; C22B 26/12

(52) U.S. Cl. CPC C01D 15/08; B01J 19/24; C22B 26/12

(57) ABSTRACT

A system and method for recovering lithium carbonate from lithium-bearing aqueous solutions using controlled droplet-phase carbonation. An alkaline lithium-bearing solution is atomized to form liquid droplets that are introduced into a reaction chamber containing a controlled carbon dioxide-rich gas flow. Carbon dioxide diffuses into the suspended droplets and reacts with dissolved lithium species to nucleate and precipitate lithium carbonate within the droplets while the droplets remain suspended in the gas environment and prior to substantial deposition on internal reactor surfaces. The reaction occurs outside of any bulk liquid bath. Partial evaporation of water may occur during droplet suspension. Resulting lithium carbonate particles are separated from the gas stream using a particulate separation system. The system may operate in a continuous flow configuration and may include optional pretreatment, gas recycling, spatially differentiated gas regions, and thermal management components configured to remove water vapor and recover thermal energy. By coordinating gas-liquid mass transfer, droplet suspension, and precipitation timing, the system enables controlled in-air carbonation and continuous lithium recovery.

### 2. CROSS-REFERENCE TO RELATED APPLICATIONS

This application claims the benefit of U.S. Provisional Ser. No. 63/791,081, filed Apr. 18, 2025, the entire contents of which are incorporated herein by reference.

### 3. FIELD OF THE INVENTION

The present invention relates generally to lithium recovery systems and, more particularly, to droplet-phase carbonation reactors for recovering lithium carbonate from lithium-bearing aqueous solutions through controlled gas-liquid reaction within suspended droplets.

### 4. BACKGROUND OF THE INVENTION

Lithium carbonate is commonly recovered from lithium-bearing brines using large-scale evaporation ponds, bulk chemical precipitation reactors, or combinations of concentration, chemical treatment, and downstream solid-liquid separation processes. In conventional pond-based systems, brine is distributed over extensive surface areas and allowed to evaporate over prolonged periods to concentrate lithium prior to chemical conversion. Such systems are typically climate-dependent, require substantial land area, and rely on ambient environmental conditions to drive moisture removal and concentration.

Alternative approaches employ stirred tank reactors, bubble columns, or similar bulk liquid systems in which carbon dioxide or carbonate-containing reagents are introduced into a lithium-containing solution. In these systems, carbonation occurs within a continuous liquid phase. Reaction rates are governed by bulk mixing and gas-liquid mass transfer across relatively large liquid volumes. Precipitated solids form within the reactor volume and may accumulate on internal surfaces, gas spargers, and mixing components, often requiring mechanical agitation and periodic cleaning.

In bulk liquid carbonation systems, precipitation timing and location are largely determined by overall mixing conditions rather than by engineered coordination of reaction kinetics relative to reactor surface contact. Surface deposition, scaling, and fouling may occur when solids form in proximity to wetted internal surfaces. Such accumulation can interfere with continuous operation and may necessitate shutdown, maintenance, or additional agitation mechanisms.

Spray drying systems are also known for processing liquid feeds; however, such systems are designed for thermal drying and solvent removal and do not include a controlled carbon dioxide-rich gas flow maintained to drive in-droplet carbonation within suspended droplets.

Existing lithium recovery approaches therefore do not provide a controlled reaction environment in which gas-liquid mass transfer, droplet suspension, precipitation timing, and moisture removal are coordinated within suspended droplets in a gas phase and outside of any bulk liquid bath. Furthermore, conventional systems provide limited capability to manage the relative precipitation behavior of lithium carbonate and co-present salts within individual reaction domains, or to integrate thermodynamic recovery and controlled humidity management within a compact reactor architecture.

Accordingly, there exists a need for a system and method that enable controlled carbonation of lithium-bearing aqueous solutions within suspended droplets dispersed in a gas environment, wherein droplet residence time, gas composition, humidity, and thermal conditions can be regulated to coordinate in-droplet reaction kinetics, precipitation timing, salt behavior, and moisture removal while reducing surface deposition and enabling continuous operation in a compact and deployable configuration.

### 5. SUMMARY OF THE INVENTION

The present invention relates to systems and methods for recovering lithium carbonate from lithium-bearing aqueous solutions through controlled droplet-phase carbonation conducted within suspended liquid droplets dispersed in a gas environment.

In contrast to bulk liquid reactors, evaporation ponds, or conventional spray drying systems, the disclosed system performs a carbon dioxide-driven chemical reaction within discrete suspended droplets rather than within a continuous liquid phase. Each droplet functions as a transient reaction domain in which carbon dioxide diffuses from a surrounding carbon dioxide-rich gas flow into the liquid phase and reacts with dissolved lithium species under alkaline conditions to form lithium carbonate.

In one aspect, a lithium-bearing aqueous solution is adjusted to alkaline conditions and atomized into droplets that are introduced into a reaction chamber containing a controlled carbon dioxide-rich gas flow. Gas composition, flow characteristics, humidity, and residence time may be regulated to maintain the droplets in suspension for a duration sufficient to permit gas-liquid mass transfer and in-droplet nucleation and precipitation of lithium carbonate. The system is configured such that precipitation occurs while the droplets remain suspended within the gas flow and prior to substantial deposition of the droplets on internal reactor surfaces, and outside of any bulk liquid bath.

By coordinating droplet suspension, gas-liquid mass transfer, and precipitation timing, the system reduces surface deposition and supports continuous operation without reliance on mechanical agitation of a bulk liquid volume. Partial evaporation of water during droplet suspension may occur concurrently with in-droplet carbonation, enhancing supersaturation and integrating reaction kinetics with moisture removal within a compact reactor architecture.

In certain embodiments, the reaction chamber may include spatially differentiated regions having differing gas composition, humidity, temperature, or velocity characteristics to coordinate nucleation, evaporation, and residence time during droplet suspension. Gas introduction structures may establish localized early-stage interaction regions proximate to droplet formation to enhance gas-liquid mass transfer prior to full entrainment within the chamber.

In certain embodiments, the lithium-bearing solution may be conditioned prior to atomization to influence relative precipitation behavior of lithium carbonate and one or more co-present dissolved salts. Such conditioning may include dilution, adjustment of ionic strength, or other modifications selected to influence in-droplet precipitation timing or downstream mechanical separability. Particulate material recovered from the gas stream may be subjected to cyclone separation, filtration, electrostatic classification, or differential aerodynamic separation.

In certain embodiments, the system may further include a gas management system and thermal management system configured to withdraw a water vapor-containing process gas stream from the reaction chamber, remove at least a portion of the water vapor, and return conditioned gas to the chamber. Latent heat released during condensation may be transferred to at least one incoming process stream to improve energy efficiency while maintaining controlled droplet-phase carbonation conditions. Condensed water may optionally be reused for solution conditioning.

The disclosed systems and methods enable controlled in-air carbonation of lithium-bearing aqueous solutions within suspended droplets, coordinated precipitation timing relative to surface contact, and integrated moisture management within a compact and deployable configuration suitable for continuous operation.

### 6. BRIEF DESCRIPTION OF THE DRAWINGS

FIG. 1 illustrates a system-level architecture of the lithium recovery system including pretreatment, atomization, reaction, separation, and gas management subsystems.

FIG. 2 illustrates a reactor assembly including an atomization nozzle, reaction chamber, gas introduction structures configured to deliver carbon dioxide-rich gas into the chamber, and a reactor outlet.

FIG. 3 illustrates a conceptual representation of droplet-scale reaction processes including carbon dioxide diffusion, water evaporation, and lithium carbonate nucleation.

FIG. 4 illustrates a reactor module showing spatially differentiated reaction regions within the droplet suspension region including an upper reaction region, an intermediate suspension region, and a lower evaporation or drying region.

FIG. 5 illustrates an injection and mixing arrangement including a brine inlet, a mixing shroud, and conceptual reaction zones within the droplet suspension region including a carbon dioxide diffusion zone, a lithium carbonate precipitation zone, and an evaporation zone.

FIG. 6 illustrates a gas management system positioned downstream of the reactor, including a cyclone separator, condensation and dehumidification system, heat exchanger, recycle blower, and carbon dioxide addition point configured to condition and recirculate process gas.

FIG. 7 illustrates a particulate conditioning and classification architecture positioned downstream of the droplet-phase carbonation reactor outlet, including a first coarse conditioning stage configured to disrupt large agglomerates and composite structures, a second fine conditioning stage configured to liberate residual salt shells or smaller composite assemblies, a selective particle charging stage configured to impart differential electrostatic charge to lithium carbonate particles relative to co-present salt particles, a multi-cut classification stage configured to generate a lithium carbonate-enriched product stream, an oversize or incompletely liberated composite stream suitable for recirculation to the first conditioning stage, and a salt-rich waste stream suitable for discharge or further processing, wherein the oversize stream is recirculated in a closed-loop configuration to the first conditioning stage.

FIG. 8 illustrates a droplet reaction timeline including droplet formation, carbon dioxide diffusion, lithium carbonate formation, evaporation, and dry particle formation.

### 7. DETAILED DESCRIPTION OF THE INVENTION

### 7.1 General Reactor Architecture

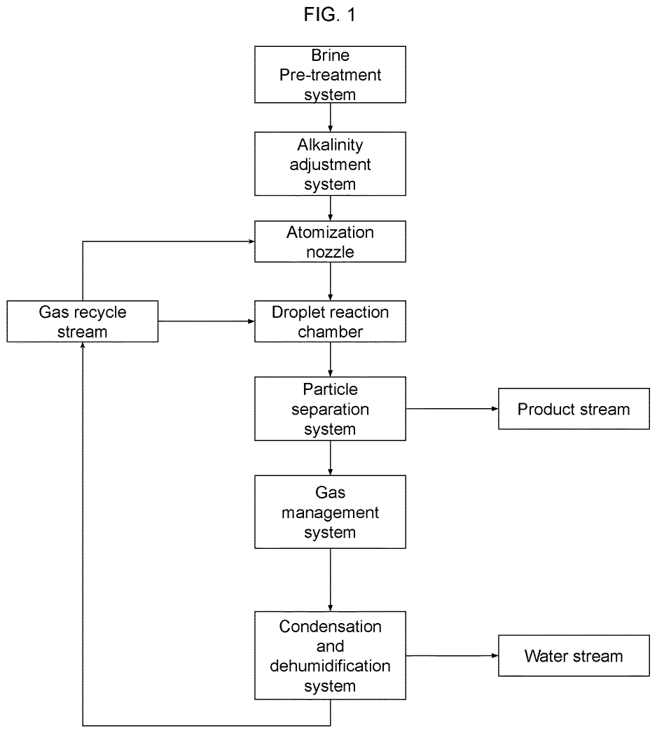

Referring to FIG. 1, the lithium recovery system may include a brine pretreatment system, an alkalinity adjustment system, an atomization stage configured to generate droplets, a droplet reaction chamber, a particulate separation system, and a gas management system arranged in a continuous process configuration.

In the disclosed system, a lithium-bearing aqueous solution is conditioned prior to atomization. Magnesium and calcium ions may optionally be removed using known pretreatment methods. The solution is adjusted to alkaline conditions sufficient to promote carbonate formation when carbon dioxide diffuses into droplets during suspension within the reaction chamber. In certain embodiments the alkalinity adjustment may be performed downstream of impurity removal and immediately prior to atomization. In certain embodiments the aqueous solution may be adjusted to a pH greater than approximately 9. In other embodiments the solution may be adjusted to a pH between approximately 10.0 and 11.5, and in certain embodiments between approximately 10.5 and 11.0. Suitable bases for alkalinity adjustment may include sodium hydroxide, potassium hydroxide, lithium hydroxide, or other alkaline reagents capable of increasing pH without introducing contaminants that interfere with lithium carbonate precipitation.

The alkaline lithium-bearing solution is then atomized to produce a plurality of liquid droplets. In certain embodiments, the atomization stage may produce droplets having diameters within a micron-scale range. In certain embodiments, droplet diameters may range from approximately 1 micrometer to about 200 micrometers, and in certain embodiments from about 5 to 50 micrometers. The droplets are introduced into a reaction chamber (230) containing a controlled carbon dioxide-rich gas flow. In certain embodiments, the carbon dioxide-rich gas flow may contain carbon dioxide in a concentration greater than that present in ambient air. For example, the gas stream may contain from about 2% to about 100% carbon dioxide by volume, and in certain embodiments from about 5% to about 50% carbon dioxide by volume. The carbon dioxide-rich gas may comprise substantially pure carbon dioxide or a mixture of carbon dioxide with one or more carrier gases including air, nitrogen, or recycled process gas.

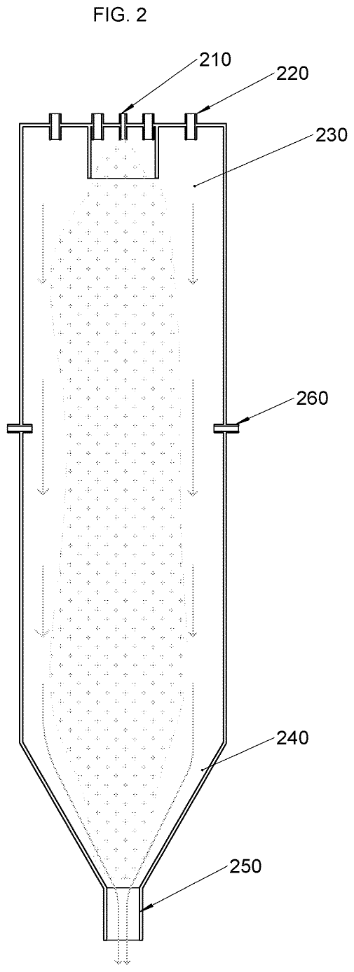

Referring to FIG. 2, one embodiment of a reactor apparatus (200) may include an atomization nozzle (210), gas inlet ports (220), the reaction chamber (230), a conical transition section (240), a particle-gas outlet (250), and optional side gas ports (260). The controlled gas flow may be axial, upward, downward, co-current, counter-current, or otherwise configured to regulate droplet residence time within the chamber.

The gas flow is regulated to maintain the droplets in suspension within the reaction chamber for a defined residence time. Suspension may be achieved through selection of gas velocity, chamber geometry, droplet size distribution, or combinations thereof. The controlled gas environment maintains droplet dispersion such that droplet residence time allows carbon dioxide diffusion, in-droplet carbonation, and lithium carbonate nucleation to occur prior to substantial droplet impingement or deposition on internal reactor surfaces.

In certain embodiments, the controlled gas flow velocity is selected relative to the droplet size distribution such that the upward or axial gas velocity counteracts gravitational settling of the droplets for at least a portion of the residence time. Chamber geometry, flow direction, and gas velocity may be configured to maintain the droplets entrained within the gas stream until a desired degree of carbonation and precipitation is achieved. By coordinating droplet terminal velocity and gas flow characteristics, the system enables controlled suspension without reliance on mechanical agitation.

In certain embodiments, the lithium recovery system may include a plurality of droplet-phase reactor chambers arranged in parallel. Each reactor chamber may receive lithium-bearing solution from a shared brine distribution manifold and may discharge process gas into a shared gas management system. The gas management system may circulate process gas through multiple reactor chambers while maintaining controlled carbon dioxide concentration, humidity, temperature, and flow conditions. Such parallel reactor configurations may allow scalable throughput by increasing the number of reactor units operating simultaneously. Individual reactor chambers may be operated independently, isolated for maintenance, or brought on-line or off-line without interrupting operation of other reactor chambers within the system.

In certain embodiments, brine or partially reacted solution exiting the reaction chamber may be collected and reintroduced into the atomization stage for one or more additional atomization cycles. Such multi-pass operation may improve lithium recovery yield from low-concentration brines by subjecting partially reacted solution to repeated droplet-phase carbonation without requiring intermediate concentration steps.

### 7.2 Droplet-phase Reaction Kinetics

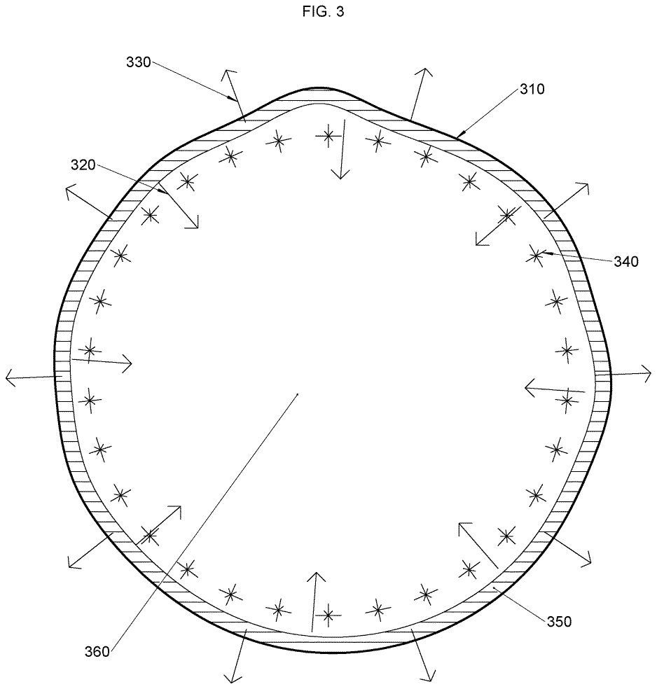

Each suspended droplet functions as a transient microreactor constituting a discrete reaction domain spatially separated from reactor walls and from other droplets during suspension within the controlled gas environment of the reaction chamber (230). Referring to FIG. 3, a suspended droplet is shown with a droplet boundary (310) separating the droplet liquid core region (360) from the surrounding gas phase. Carbon dioxide diffuses toward the droplet along diffusion direction(s) (320) from a surrounding carbon dioxide diffusion region (350), while water vapor evaporates outward from the droplet along evaporation direction(s) (330). Lithium carbonate nucleation (340) and initial particle formation occur within the droplet liquid core region (360) during suspension.

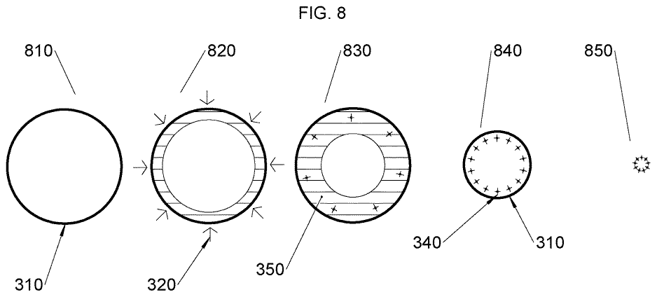

Referring to FIG. 8, the droplet reaction process may proceed through a sequence including droplet formation (810), carbon dioxide diffusion into the droplet (820), lithium carbonate formation (830), partial evaporation of water (840), and eventual formation of dry particles (850).

Carbon dioxide present in the gas phase diffuses across the gas-liquid interface of the droplet and dissolves into the aqueous phase. Within the droplet, dissolved carbon dioxide reacts with hydroxide and lithium species to form carbonate ions and subsequently lithium carbonate. In certain embodiments, nucleation of lithium carbonate within suspended droplets may be promoted through introduction of nucleation agents including lithium carbonate seed crystals, finely divided mineral particles capable of serving as heterogeneous nucleation surfaces, surface-active species, or combinations thereof.

The rate of lithium carbonate formation may be governed by: gas-liquid mass transfer of carbon dioxide into the droplet, chemical reaction kinetics within the liquid phase, droplet surface area-to-volume ratio, and residence time of the droplet within the controlled gas environment.

The relative rates of carbon dioxide diffusion and in-droplet reaction may be selected such that supersaturation and lithium carbonate nucleation occur within the droplet during suspension. In certain embodiments, gas composition and residence time are coordinated to favor chemical reaction-driven precipitation rather than evaporation-driven surface crystallization.

Because the droplets are dispersed within the gas flow rather than contained within a bulk liquid volume, reaction kinetics are influenced by interfacial mass transfer conditions specific to each droplet rather than by bulk mixing dynamics.

In conventional spray drying systems, droplet evaporation is typically the dominant mechanism leading to solute crystallization as solvent is removed. In contrast, the present system promotes lithium carbonate formation primarily through carbon dioxide diffusion and in-droplet chemical reaction during droplet suspension. Although partial evaporation may occur, precipitation is driven principally by carbonation reaction kinetics rather than by solvent evaporation alone.

In certain embodiments, evaporation conditions may be controlled such that internal circulation is maintained within suspended droplets during at least a portion of the reaction period. Internal circulation may reduce solute accumulation at the droplet surface and thereby reduce formation of shell-like crystalline structures of co-present salts. Maintaining such internal mixing may promote precipitation of lithium carbonate within the interior of the droplet while delaying crystallization of other dissolved salts.

### 7.3 Precipitation Timing Relative to Surface Contact

As carbon dioxide diffuses into the droplet and reacts, lithium carbonate nucleates and precipitates within the liquid phase of the droplet. In certain embodiments, the droplets may undergo partial evaporation of water while suspended in the gas flow, which can increase supersaturation and promote nucleation.

The system is configured such that nucleation and precipitation occur while the droplets remain suspended within the reaction chamber and prior to substantial deposition of the droplets on internal reactor surfaces. Substantial deposition refers to sustained accumulation of material on internal wetted surfaces sufficient to interfere with continuous reactor operation, for example accumulation that produces measurable fouling, pressure drop, flow obstruction, or surface coverage that impairs stable droplet suspension within the reaction chamber.

By coordinating droplet residence time, gas composition, and reaction kinetics, the system enables precipitation to occur predominantly within suspended droplets rather than on chamber walls. This controlled precipitation timing reduces surface deposition and facilitates continuous operation.

In certain embodiments, droplet residence time and gas composition are selected such that lithium carbonate nucleation and at least partial particle growth occur while the droplets remain suspended within the gas flow prior to significant droplet-wall interaction.

### 7.4 Absence of Bulk Liquid Reaction Zone

The carbonation reaction occurs within suspended droplets dispersed in the gas phase and outside of any bulk liquid bath. The reaction chamber does not rely on a continuous liquid reactor volume, mechanical agitation, or gas sparging within a tank and is not dependent upon mechanical agitation of a bulk liquid phase to sustain the carbonation reaction.

This configuration distinguishes the system from stirred tank reactors, bubble columns, and similar bulk-phase carbonation systems in which precipitation occurs within a continuous liquid environment.

As used herein, a bulk liquid bath refers to a continuous liquid body serving as the primary reaction medium, as distinguished from suspended droplets, transient collected droplets, wetted surfaces, or downstream collected liquid obtained after droplet capture.

### 7.5 Solid Formation and Separation

As reaction proceeds and droplets partially evaporate, lithium carbonate particles remain suspended in the gas stream. A particulate separation system, such as a cyclone separator, filter, or electrostatic separator, may be used to recover the solid lithium carbonate from the gas stream.

In certain embodiments, droplets containing precipitated lithium carbonate particles may be captured prior to complete evaporation of the droplet liquid phase. Such capture may be achieved using mist separators, impingement collectors, wetted wall separators, inertial droplet collectors, or other droplet capture mechanisms configured to remove liquid droplets from the gas stream. The collected liquid phase may contain suspended lithium carbonate particles while one or more co-present salts remain dissolved. The collected liquid may subsequently be subjected to downstream solid-liquid separation processes including filtration, settling, centrifugation, or other separation methods to recover lithium carbonate particles from the liquid phase.

Recovered gas may optionally be recycled, and thermal energy may optionally be recovered from outgoing vapor streams.

### 7.6 Reduction of Reactor Fouling

In conventional bulk liquid carbonation systems, precipitation may occur throughout the reactor volume without control over the timing of nucleation relative to surface contact. Solids formed in such environments may accumulate on internal surfaces, gas spargers, mixing elements, and vessel walls, often requiring mechanical agitation or periodic cleaning.

In contrast, the present system coordinates droplet suspension time and reaction kinetics such that lithium carbonate nucleates and precipitates predominantly within suspended droplets prior to substantial droplet impingement on reactor surfaces. Because each droplet functions as an isolated microreactor, precipitation occurs within the liquid volume of the droplet. Because precipitation is initiated within suspended droplets rather than on static wetted surfaces, the system reduces the formation of adherent scale layers associated with bulk liquid reactors or premature droplet-wall impingement.

By maintaining the droplets in suspension within a controlled carbon dioxide-rich gas flow during reaction, the system reduces the likelihood of premature surface deposition. The coordination of gas-liquid mass transfer, droplet residence time, and precipitation timing thereby mitigates reactor fouling and supports continuous operation without reliance on mechanical agitation or large liquid reactor volumes.

### 7.7 Enhanced Water Removal and Environmental Independence

In evaporation pond systems, water removal depends on ambient environmental conditions, including temperature, humidity, solar exposure, and wind. Such systems typically operate over extended time periods and are geographically constrained to climates that support high natural evaporation rates.

In the disclosed droplet-phase reactor, water removal occurs through controlled evaporation from suspended droplets within the gas environment. The high surface-area-to-volume ratio of the droplets substantially increases interfacial area available for mass transfer relative to bulk liquid systems. As a result, evaporation rates are governed by engineered gas flow conditions rather than by ambient climate.

Because droplet suspension, gas composition, and residence time are actively controlled within the reaction chamber, the system enables coordinated chemical reaction and moisture removal independent of solar exposure or large land area. Operation may therefore be conducted continuously and in a wide range of geographic environments, including regions unsuitable for traditional evaporation pond systems.

In certain embodiments, partial evaporation of water during droplet suspension may enhance supersaturation and promote in-droplet nucleation of lithium carbonate, further integrating reaction kinetics and water removal within a compact reactor architecture.

### 7.8 Thermal Management

In certain embodiments, the system may include a thermal management system configured to transfer thermal energy from at least one outgoing process stream to at least one incoming process stream. Thermal energy may be recovered from vapor, gas, or other effluent streams and utilized to precondition incoming process streams. Such thermal management may improve overall energy efficiency while maintaining controlled droplet-phase carbonation conditions within the reaction chamber. The thermal management system may comprise one or more indirect heat exchangers, regenerative thermal elements, or other energy transfer mechanisms.

### 7.9 Zoned Reaction Chamber Embodiments

In certain embodiments, the reaction chamber may be configured to establish spatially differentiated reaction environments within the droplet suspension region. Such zoning may be achieved through controlled introduction of one or more gas streams, chamber geometry, staged gas injection, or flow redirection within the chamber.

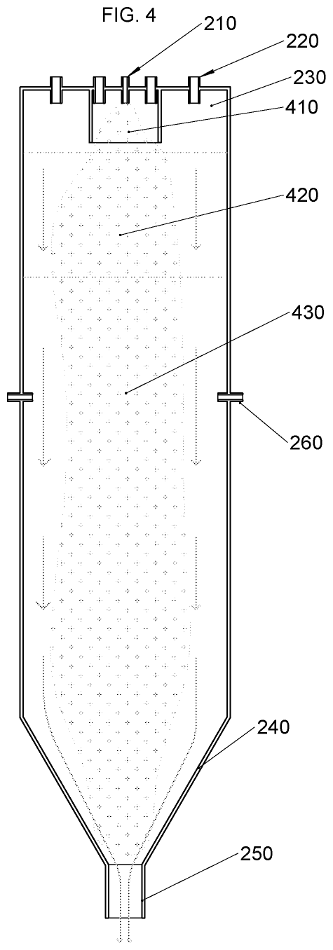

Referring to FIG. 4, the reaction chamber (230) may, in certain embodiments, include spatially differentiated regions including an upper reaction region (410), an intermediate suspension region (420), and a lower evaporation region (430). The chamber may define two or more regions having differing gas composition, humidity, temperature, or velocity characteristics. These regions may be arranged along the droplet suspension path within a single chamber volume or across connected chamber volumes. By controlling these parameters spatially, the system may coordinate gas-liquid mass transfer, evaporation behavior, and droplet residence time during droplet suspension.

### 7.9.1 Gas Composition Zoning

In certain embodiments, a first region of the chamber may contain a relatively higher carbon dioxide partial pressure to promote rapid gas-liquid mass transfer and initiate lithium carbonate nucleation within suspended droplets. Downstream or radially offset regions may contain a reduced carbon dioxide concentration to modulate reaction rate, control crystal growth, or reduce excessive secondary precipitation.

Carbon dioxide may be introduced through one or more gas introduction structures positioned along the droplet suspension path to create controlled concentration gradients within the chamber. Gas streams may mix immediately or progressively within the chamber to create controlled gradients rather than uniform composition.

### 7.9.2 Humidity and Evaporation Zoning

In certain embodiments, spatial variation in humidity may be used to coordinate reaction kinetics and evaporation. An initial region may limit rapid drying to allow controlled in-droplet carbonation, while a subsequent region may promote enhanced evaporation to increase supersaturation and complete precipitation.

Humidity conditions may be regulated through staged gas introduction or conditioning of recirculated process gas.

### 7.9.3 Velocity and Residence Time Zoning

Spatial variation in gas velocity or flow direction may be used to regulate droplet residence time within specific regions of the chamber. For example, a first region may be configured to extend droplet suspension time to allow nucleation, while a subsequent region may alter velocity or flow pattern to facilitate drying and downstream separation.

Such control may be achieved through chamber geometry, flow-directing structures, or staged gas introduction while maintaining droplet suspension and minimizing substantial deposition on internal reactor surfaces.

### 7.9.4 Coordination of Reaction and Co-present Salt Behavior

In certain embodiments of the droplet-phase carbonation system, spatial zoning may be used to influence the relative timing of lithium carbonate precipitation and the behavior of co-present salts within suspended droplets. By modulating gas composition, humidity, temperature, residence time, or droplet size distribution within defined regions of the chamber, lithium carbonate nucleation may be promoted during droplet suspension while maintaining other dissolved salts in solution during at least a portion of the reaction period.

Such coordination may reduce formation of composite or shell structures and may enhance downstream mechanical separation of lithium carbonate from co-present salts.

### 7.10 Injection and Mixing Control Embodiments

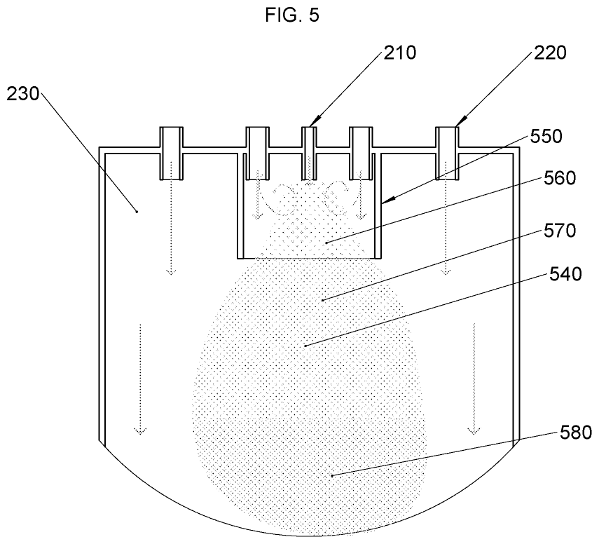

In certain embodiments, the atomization assembly and gas introduction structure may be configured to control early-stage interaction between newly formed droplets and one or more gas streams prior to full entrainment within the broader droplet suspension region of the reaction chamber. The zoning concepts illustrated in FIG. 4 and FIG. 5 represent different conceptual descriptions of the same reaction progression and may correspond to the same physical chamber regions in certain embodiments.

Referring to FIG. 5, brine may be introduced through a brine inlet (540) and may interact with one or more surrounding gas streams delivered through a mixing shroud (550). Within the droplet suspension region of the reaction chamber (230), spatially differentiated process zones may form including a carbon dioxide diffusion zone (560), a lithium carbonate precipitation zone (570), and an evaporation zone (580).

The injection and mixing configuration may establish a localized interaction region in which carbon dioxide is introduced in proximity to newly formed droplets to promote rapid gas-liquid mass transfer and initiate carbonation. This localized region may be spatially confined relative to the overall chamber volume and may precede or overlap with a broader suspension region in which droplets are maintained for continued reaction and evaporation.

Gas introduction may be arranged and modulated to influence droplet trajectory, mixing behavior, residence time, and early-stage reaction kinetics within the droplet suspension region.

In certain embodiments, the localized interaction region may exhibit increased mixing intensity to enhance gas-liquid interfacial mass transfer, followed by transition into a region characterized by controlled flow conditions configured to maintain droplet suspension and minimize substantial deposition on internal reactor surfaces.

By coordinating droplet formation, gas introduction, and early-stage mixing, the system may influence nucleation timing, evaporation behavior, and droplet stability within the droplet suspension region.

### 7.11 Salt-management and Precipitation-control Embodiments

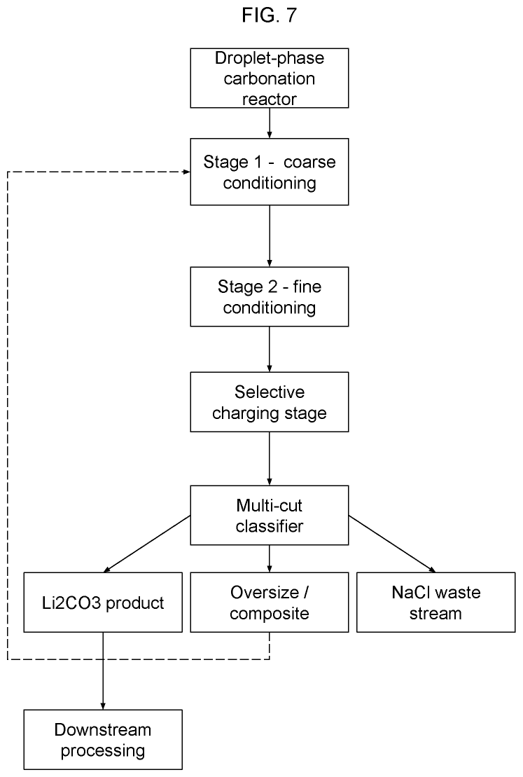

Referring to FIG. 7, various embodiments may include solution conditioning, particle conditioning, and downstream separation techniques configured to influence precipitation behavior of lithium carbonate relative to co-present salts and to enhance downstream particulate classification.

In certain embodiments, the lithium-bearing aqueous solution may be conditioned prior to atomization to influence the relative precipitation behavior of lithium carbonate and one or more co-present dissolved salts within suspended droplets.

In certain embodiments, particulate material exiting the droplet reaction chamber may be directed to a particle conditioning and classification system as further described herein and illustrated in FIG. 7. The approaches illustrated in FIG. 7 may be used individually or in combination to coordinate lithium carbonate precipitation and downstream separation of lithium carbonate particles from co-present salts.

### 7.11.1 Pre-Atomization Dilution or Ionic Strength Adjustment

In certain embodiments, the aqueous solution may be diluted or otherwise adjusted prior to atomization to reduce initial ionic strength or supersaturation of at least one dissolved salt species. Such adjustment may influence relative precipitation timing during droplet suspension and may reduce formation of composite or shell-like structures within partially evaporating droplets.

Dilution may be achieved by introduction of water, recycled condensate, or other compatible liquid streams. The degree of dilution may be selected to coordinate lithium carbonate nucleation and co-present salt solubility during droplet suspension.

In certain embodiments, gas composition, humidity, residence time, droplet size distribution, dilution, or combinations thereof may be selected such that lithium carbonate nucleates and precipitates within suspended droplets while at least one co-present salt species remains substantially dissolved within the droplet liquid phase during a portion of droplet suspension. Under such conditions, droplets containing suspended lithium carbonate particles may be collected prior to complete evaporation of the liquid phase. The collected liquid phase may subsequently be subjected to solid-liquid separation processes including filtration, centrifugation, settling, or other separation techniques to recover lithium carbonate while the dissolved salts remain in solution. Such embodiments may reduce formation of composite or shell-like particle structures and may enhance downstream separability of lithium carbonate relative to co-present salts.

### 7.11.2 In-flight or Pre-separation Shear Conditioning

In certain embodiments, particles formed within suspended droplets may be subjected to one or more conditioning forces prior to particulate separation. Such conditioning may reduce agglomeration, disrupt loosely associated composite structures, liberate lithium carbonate particles from co-present salt species, or enhance downstream classification efficiency. The particle conditioning stage may be positioned directly downstream of the droplet-phase carbonation reactor outlet and upstream of one or more particulate classification systems.

Representative conditioning mechanisms include, without limitation, gas-phase shear conditioning, jet-impingement conditioning, vortex or swirl-induced shear, fluidized particle collision conditioning, acoustic or ultrasonic excitation, and mechanical impact conditioning. These mechanisms may be applied individually or in combination, and the conditioning architecture may be selected based on the salt composition, particle morphology, and composite structure characteristics of a given brine feedstock.

In certain embodiments, conditioning may be achieved through gas-phase shear using high-velocity flow directed at the particulate stream exiting the reaction chamber. A high-velocity gas jet or nozzle array may be positioned downstream of the droplet suspension region and upstream of the particulate separation system to impart shear forces sufficient to disrupt agglomerated or composite particle structures. The velocity and direction of the conditioning flow may be selected relative to the particle size distribution and expected composite structure morphology to maximize liberation efficiency while minimizing excessive particle attrition.

In certain embodiments, conditioning may include turbulent flow or jet-impingement conditioning. Particles entrained in the process gas stream may pass through a turbulent flow region, impingement surface, or jet-impingement chamber configured to subject particles to repeated high-energy collisions and shear events. Such turbulent impingement conditioning may disrupt salt shells or loosely bonded composite structures formed during droplet evaporation.

In certain embodiments, conditioning may include vortex or swirl-induced shear. Particles may pass through a swirl chamber or cyclonic conditioning stage in which centrifugal and tangential flow components generate shear forces acting on composite particle structures. The swirl intensity and chamber geometry may be selected to disrupt agglomerates while maintaining a controllable particle size distribution suitable for downstream classification.

In certain embodiments, conditioning may include fluidized particle collision conditioning. Particles may be introduced into a fluidized conditioning zone in which gas velocity is regulated to maintain particles in a fluidized or semi-fluidized state, promoting inter-particle collisions at controlled energy levels. Such collisions may progressively liberate lithium carbonate particles from composite or agglomerated structures through repeated low-energy contact rather than single high-energy impact events.

In certain embodiments, conditioning may include acoustic or ultrasonic excitation. An acoustic transducer or ultrasonic source may direct acoustic energy into the particulate stream or a conditioning chamber, generating pressure oscillations sufficient to disrupt loosely bonded agglomerates or composite particle structures. Acoustic conditioning may be applied continuously or in intermittent bursts, and the frequency and intensity of acoustic excitation may be selected to target the mechanical properties of salt-shell or composite structures expected to form during droplet-phase carbonation.

In certain embodiments, two or more conditioning mechanisms may be applied in sequence or combination. For example, an initial vortex shear stage may be followed by acoustic conditioning, or jet-impingement conditioning may be combined with downstream fluidized collision stages. The conditioning architecture may include modular stages allowing selection and arrangement of conditioning mechanisms appropriate to the salt composition and particle morphology of a given brine feedstock.

### 7.11.3 Differential or Electrostatic Classification

In certain embodiments, particulate separation may include electrostatic classification, differential aerodynamic separation, or other mechanisms configured to preferentially separate particles based on size, charge, density, or surface properties. Such classification may enhance separation of lithium carbonate from co-present particulate species. In certain embodiments, lithium carbonate particles may exhibit aerodynamic, density, or electrostatic properties distinct from co-present sodium chloride particles produced during droplet evaporation, enabling preferential classification of lithium carbonate relative to sodium chloride.

### 7.11.4 Staged Liberation and Multi-cut Classification Architectures

In certain embodiments, and as further illustrated by the particulate conditioning and classification architecture shown in FIG. 7, the particulate handling system may include a staged architecture in which particle liberation and classification are performed in sequential discrete stages rather than in a single combined unit operation. Such staged architectures may improve separation efficiency by allowing each stage to be optimized for a specific particle property range or composite structure type.

In certain embodiments, a first liberation stage may include coarse disruption of large agglomerates and composite structures, followed by a second liberation stage comprising finer conditioning targeted at residual salt shells or smaller composite assemblies. The conditioned particle stream may then pass to a classification stage that exploits the improved morphological uniformity achieved by staged liberation.

In certain embodiments, the classification system may include a multi-cut classifier generating three or more output streams characterized by differing particle size ranges, densities, or aerodynamic properties. A first output stream may be enriched in lithium carbonate particles of a target size range. A second output stream may contain oversize particles or incompletely liberated composites suitable for reintroduction into a liberation stage. A third output stream may contain fine particulate material or salt-rich fines suitable for discharge or further processing. Such multi-cut classification may improve lithium carbonate product purity relative to single-cut separation approaches.

In certain embodiments, classification stages may be arranged in series such that each successive classifier operates on a progressively narrower particle size or density distribution. Intermediate classifier outlets may recirculate off-specification fractions to an upstream liberation stage or to an additional conditioning zone, forming a closed-loop particle processing circuit configured to maximize lithium carbonate recovery and purity.

In certain embodiments, the staged liberation and classification architecture may be integrated with the gas management system of the droplet-phase carbonation reactor. Process gas exiting the reactor may carry entrained particulate material directly into the liberation and classification circuit, and conditioned classification gas may be returned to the gas management system for humidity and carbon dioxide conditioning prior to reuse. Such integration may reduce the need for intermediate solids-handling steps between the reactor and the classification system and may support continuous operation of the combined reactor and separation architecture.

In certain embodiments, particle size distribution measurements may be used to adjust operating conditions of the liberation or classification stages, including conditioning intensity, classifier cut points, or recirculation ratios, in response to observed particle property distributions.

### 7.11.5 Selective Particle Charging and Electrostatic Separation

In certain embodiments, and with reference to the classification architecture illustrated in FIG. 7, the particulate separation system may include a selective particle charging stage configured to impart differential electrostatic charge to lithium carbonate particles relative to co-present salt particles such as sodium chloride. Differential charging may exploit differences in surface properties, dielectric constant, conductivity, or particle morphology between lithium carbonate and co-present salt species to generate charge distributions that facilitate downstream electrostatic classification.

In certain embodiments, selective charging may include triboelectric charging in which particles pass through a charging zone containing surfaces selected for their triboelectric affinity toward lithium carbonate or co-present salts. Lithium carbonate particles and sodium chloride or other salt particles may acquire charges of differing polarity or magnitude upon contact with the triboelectric surface, enabling downstream deflection or collection based on charge state.

In certain embodiments, selective charging may include corona discharge charging in which particles pass through a controlled ionization field generated by one or more corona discharge electrodes. The intensity, geometry, and polarity of the corona discharge may be selected to preferentially charge particle species having surface properties or conductivities characteristic of lithium carbonate relative to co-present salt species.

In certain embodiments, selective charging may include induction charging in which particles pass near a grounded or biased electrode in a controlled manner. Differences in dielectric properties between lithium carbonate and co-present salts may result in differential charge induction, which may be exploited in a subsequent electrostatic deflection or collection stage.

In certain embodiments, a particle conditioning stage as described in section 7.11.2 may be positioned upstream of the selective charging stage to prepare particle surfaces for differential charging. Such conditioning may include exposure to controlled humidity, surface-active agents, or thermal treatment configured to modify the surface charge receptivity of lithium carbonate or co-present salt particles prior to entry into the charging zone. Liberation conditioning may be combined with surface preparation conditioning to produce a particle stream having both improved morphological uniformity and enhanced surface charge contrast between lithium carbonate and salt species.

In certain embodiments, the selectively charged particle stream may pass through an electrostatic separator comprising one or more deflection electrodes, collection surfaces, or electrostatic classifier channels configured to separate particles based on their acquired charge state. The electrostatic separator may generate at least a lithium carbonate-enriched product stream and a salt-enriched waste stream. The product stream may be subjected to downstream washing, drying, or further classification to achieve a desired product purity specification.

In certain embodiments, the electrostatic separation stage may be combined with aerodynamic classification such that particles are subject to both electrostatic deflection forces and aerodynamic drag forces simultaneously. The combined action of electrostatic and aerodynamic separation may improve selectivity relative to either mechanism applied alone, particularly for particle populations in which lithium carbonate and co-present salt particles exhibit overlapping size distributions but differing charge or density characteristics.

### 7.12 Gas Management and Thermal Recovery Embodiments

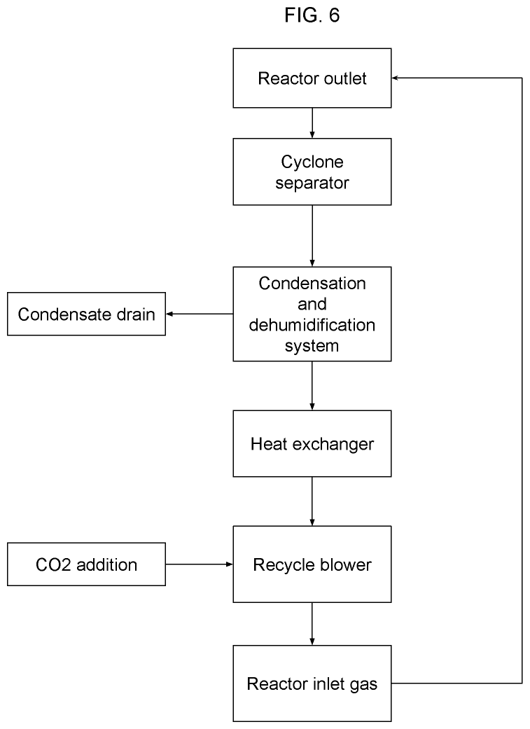

In certain embodiments, the system may include a closed-loop or partially closed-loop gas circulation architecture configured to manage humidity and thermal energy within the droplet-phase carbonation reactor. Referring to FIG. 6, gas exiting the reactor through the particle-gas outlet (250) may be directed to a downstream gas conditioning system including a cyclone separator, heat exchanger, condensation and dehumidification system, recycle blower, and carbon dioxide addition point configured to condition and recirculate process gas to the reaction chamber (230). The gas management system may be configured to withdraw a process gas stream containing water vapor from the reaction chamber (230) and condition the withdrawn gas stream prior to returning at least a portion of the gas stream to the reaction chamber.

In certain embodiments, conditioning of the withdrawn gas stream may include removal of water vapor by condensation or dehumidification. The latent heat released during condensation may be transferred to at least one incoming process stream, including an incoming gas stream provided to the reaction chamber, an incoming carbon dioxide stream, or an incoming liquid stream, to improve overall system thermal efficiency while maintaining controlled droplet-phase carbonation conditions.

In certain embodiments, the gas management system may be configured to regulate one or more parameters including gas temperature, humidity, dew point, carbon dioxide concentration, or flow rate. Such regulation may be used to maintain droplet suspension, coordinate reaction kinetics within suspended droplets, and control evaporation during droplet-phase carbonation.

In certain embodiments, the thermal management system may comprise one or more indirect heat exchangers, regenerative thermal elements, heat pump components, or combinations thereof. The thermal management system may be configured to transfer thermal energy from at least one outgoing process stream to at least one incoming process stream without requiring direct contact between the streams.

In certain embodiments, condensed water recovered from the withdrawn gas stream may be reused as dilution water for solution conditioning prior to atomization.

### 7.13 Representative Operating Example

In one representative embodiment, a lithium-bearing brine containing approximately 0.15 wt % lithium and approximately 10 wt % sodium chloride is subjected to pretreatment to remove magnesium and calcium impurities using lime precipitation followed by filtration.

Following pretreatment, the brine is adjusted to a pH of approximately 10.5 using sodium hydroxide.

The conditioned solution is supplied to an atomization nozzle configured to generate droplets having a diameter distribution between approximately 5 and 50 micrometers.

The droplets are introduced into a reaction chamber containing a carbon dioxide-rich gas stream comprising approximately 10% carbon dioxide and 90% air by volume.

Gas velocity within the droplet suspension region is maintained at approximately 3 meters per second, which maintains the droplets in suspension for a residence time of approximately 1.0 seconds.

During suspension, carbon dioxide diffuses into the droplets and reacts with dissolved lithium species under alkaline conditions to form lithium carbonate. Concurrently, partial evaporation of water occurs from the droplet surface, increasing supersaturation within the droplets and promoting nucleation and growth of lithium carbonate particles.

Following droplet-phase carbonation, lithium carbonate particles are separated from the gas stream using a cyclone separator.

Gas exiting the cyclone separator is directed to a gas conditioning system comprising a heat exchanger and condensation stage configured to remove water vapor from the gas stream. The conditioned gas is then returned to the reaction chamber to maintain controlled carbonation conditions.

The foregoing example illustrates representative operating parameters for droplet-phase carbonation within suspended droplets in a carbon dioxide-rich gas environment only and is not intended to limit the scope of the invention.

What is claimed is:

1. A method for recovering lithium carbonate from a lithium-bearing aqueous solution, comprising:
optionally removing magnesium and calcium ions from the lithium-bearing aqueous solution;
adjusting the lithium-bearing aqueous solution to alkaline conditions sufficient to promote carbonate formation;
atomizing the lithium-bearing aqueous solution into droplets;
introducing the droplets into a reaction chamber configured as a flow-through droplet-phase reactor in which the droplets are received into and conveyed through the reaction chamber by a controlled carbon dioxide-rich gas flow and discharged in a gas-particulate stream to a downstream particulate separation system;
contacting the suspended liquid droplets with the carbon dioxide-rich gas flow to permit carbon dioxide to diffuse into the droplets and react with lithium species dissolved therein, thereby causing lithium carbonate to nucleate and precipitate within the droplets while the droplets remain suspended within the carbon dioxide-rich gas flow in the reaction chamber, prior to substantial deposition of the droplets on internal reactor surfaces and outside of any bulk liquid bath; and
separating solid lithium carbonate particles from the gas-particulate stream.

2. The method of claim 1, wherein the droplets have diameters within a micron-scale range.

3. The method of claim 1, wherein the suspended liquid droplets undergo partial evaporation of water during exposure to the carbon dioxide-rich gas flow.

4. The method of claim 1, further comprising, after nucleation and precipitation of lithium carbonate within the suspended droplets, capturing droplets containing suspended lithium carbonate particles prior to complete evaporation of the droplet liquid phase and subsequently separating lithium carbonate particles from the collected liquid phase, wherein the collected liquid phase is generated by downstream capture of reacted droplets after droplet-phase precipitation within the reaction chamber.

5. The method of claim 1, wherein separating the solid lithium carbonate particles comprises use of a cyclone separator.

6. The method of claim 1, further comprising withdrawing a process gas stream from the reaction chamber.

7. The method of claim 6, further comprising conditioning the withdrawn process gas stream to modify at least one of humidity, temperature, or carbon dioxide concentration.

8. The method of claim 7, wherein conditioning comprises removing at least a portion of water vapor from the withdrawn process gas stream.

9. The method of claim 6, further comprising returning at least a portion of the withdrawn or conditioned process gas stream to the reaction chamber.

10. The method of claim 1, further comprising reprocessing unreacted brine through additional atomization cycles to improve lithium yield from low-concentration solutions.

11. The method of claim 1, further comprising establishing at least two spatially differentiated regions within the reaction chamber having differing gas composition.

12. The method of claim 1, further comprising spatially varying humidity within the reaction chamber to coordinate in-droplet carbonation and evaporation during droplet suspension.

13. The method of claim 1, further comprising introducing carbon dioxide through multiple injection points positioned along a droplet suspension path.

14. The method of claim 1, wherein at least one process parameter selected from gas composition, humidity, temperature, residence time, droplet size distribution, or dilution is controlled based on the solubility characteristics of lithium carbonate and at least one co-present dissolved salt species in the lithium-bearing aqueous solution, such that the droplet liquid phase reaches supersaturation with respect to lithium carbonate prior to reaching supersaturation with respect to the co-present dissolved salt species, causing lithium carbonate to precipitate within the droplets while the co-present salt remains substantially in solution within the droplet liquid phase during at least a portion of droplet suspension, and further comprising capturing droplets containing suspended lithium carbonate particles prior to complete evaporation of the droplet liquid phase, and subsequently separating lithium carbonate particles from the collected liquid phase by a solid-liquid separation process while the co-present dissolved salt species remains substantially dissolved in the collected liquid phase.

15. The method of claim 1, further comprising introducing carbon dioxide in proximity to newly formed droplets to establish a localized early-stage gas-liquid interaction region prior to full entrainment of the droplets within the reaction chamber.

16. The method of claim 1, further comprising conditioning the lithium-bearing aqueous solution prior to atomization to influence relative precipitation behavior of lithium carbonate and at least one co-present dissolved salt within suspended droplets.

17. The method of claim 1, further comprising electrostatic or differential aerodynamic classification of recovered particles to enhance separation of lithium carbonate from co-present particulate species.

18. A reactor apparatus for recovering lithium carbonate from a lithium-bearing aqueous solution, comprising:
an atomization assembly configured to produce droplets of the aqueous solution;
a reaction chamber configured as a flow-through droplet-phase reactor to receive atomized droplets into and convey them through the reaction chamber by a controlled carbon dioxide-rich gas flow, and to discharge a gas-particulate stream therefrom;
one or more gas introduction structures configured to introduce carbon dioxide-rich gas into the reaction chamber;
wherein the reactor apparatus is configured such that the droplets remain suspended within the controlled carbon dioxide-rich gas flow for a residence time sufficient to permit carbon dioxide to diffuse into the droplets and cause lithium carbonate to nucleate and precipitate within the droplets prior to substantial deposition of the droplets on internal reactor surfaces and outside of any bulk liquid bath; and
a particulate separation system configured to receive the gas-particulate stream from the reaction chamber and collect solid lithium carbonate therefrom.

19. The reactor apparatus of claim 18, wherein the gas introduction structures are positioned relative to the atomization assembly to establish a localized interaction region proximate to droplet formation.

20. The reactor apparatus of claim 19, wherein the gas introduction structures comprise at least one concentric, radial, axial, or tangential gas injection structure arranged to introduce carbon dioxide near the atomization assembly.

21. The reactor apparatus of claim 18, wherein at least one of the gas introduction structures are configured to create a first region of increased mixing intensity proximate to droplet formation and a second region configured to maintain controlled droplet suspension.

22. The reactor apparatus of claim 18, further comprising a gas management system configured to withdraw a process gas stream from the reaction chamber and return at least a portion of the withdrawn process gas stream to the reaction chamber.

23. A continuous lithium recovery system, comprising:
a pretreatment stage configured to optionally remove magnesium and calcium ions and adjust alkalinity of a lithium-bearing brine;
an atomization assembly configured to disperse the brine into droplets;
a reaction chamber configured as a flow-through droplet-phase reactor to receive atomized droplets and convey them through the reaction chamber by a controlled carbon dioxide-rich gas flow to cause droplet-phase carbonation within suspended liquid droplets, the droplets remaining outside of any bulk liquid bath within the reaction chamber and being discharged from the reaction chamber in a gas-particulate stream to a downstream particulate separation system;
a particulate separation system configured to recover lithium carbonate particles formed within droplets in the reactor; and
a gas management system configured to recycle at least a portion of the carbon dioxide-containing gas stream, wherein the system is configured for continuous flow operation.

24. The system of claim 23, further comprising a thermal management system configured to transfer thermal energy from at least one outgoing process stream to at least one incoming process stream.

25. The system of claim 23, further comprising a plurality of modular droplet-phase reactor units connected in parallel to a shared gas management system and brine distribution manifold.

26. The system of claim 23, wherein the reaction chamber and gas management system are jointly configured to establish, within suspended droplets in the brine feedstock, droplet conditions under which the droplet liquid phase reaches supersaturation with respect to lithium carbonate prior to reaching supersaturation with respect to at least one co-present dissolved salt species, by controlling at least one process parameter selected from gas composition, humidity, temperature, residence time, droplet size distribution, or dilution based on the solubility characteristics of lithium carbonate and the co-present dissolved salt species, and wherein the system further comprises a droplet capture stage configured to collect droplets containing suspended lithium carbonate particles prior to complete evaporation of the droplet liquid phase, and a downstream solid-liquid separation stage configured to recover lithium carbonate particles from the collected liquid phase while the co-present dissolved salt species remains substantially dissolved therein.

27. The system of claim 23, wherein the reaction chamber includes one or more gas introduction structures positioned proximate to the atomization assembly to establish a localized early-stage interaction region proximate to droplet formation.

28. The system of claim 23, wherein the gas management system is configured to withdraw a process gas stream from the reaction chamber.

29. The system of claim 28, further comprising a conditioning stage configured to modify at least one property of the withdrawn process gas stream prior to reuse or discharge.

30. The system of claim 29, wherein the conditioning stage comprises a dehumidification or condensation stage configured to remove at least a portion of water vapor from the withdrawn process gas stream.
